(19) United States
(12) Patent Application Publication
(10) Pub. No.: US 2008/0004876 A1
(43) Pub. Date: Jan. 3, 2008

(54) Non-enrolled continuous dictation

(76) Inventors: Chuang He, Westford, MA (US); Jianxiong Wu, Acton, MA (US); Paul Duchnowski, Brookline, MA (US); Neeraj Deshmukh, Waltham, MA (US)

Correspondence Address: BROMBERG & SUNSTEIN LLP, 125 SUMMER STREET, BOSTON, MA, 02110-1618, US

(21) Appl. No.: 11/478,837

(22) Filed: Jun. 30, 2006

(51) Int. Cl. G10L 15/06

(52) U.S. Cl. 704/243

(57) ABSTRACT

Speech recognition includes use of a user profile for large vocabulary continuous speech recognition which is created without using an enrollment procedure. The user profile includes speech recognition information associated with a specific user. Large vocabulary continuous speech recognition is performed on an unknown speech input from the user utilizing the information from the user profile.

### FIELD OF THE INVENTION

The invention generally relates to automatic speech recognition (ASR), and more specifically, to adaptation of the acoustic models for ASR.

### BACKGROUND ART

A speech recognition system determines representative text corresponding to input speech. Typically, the input speech is processed into a sequence of digital frames. Each frame can be thought of as a multi-dimensional vector that represents various characteristics of the speech signal present during a short time window of the speech. In a continuous recognition system, variable numbers of frames are organized as “utterances” representing a period of speech followed by a pause, which in real life loosely corresponds to a spoken sentence or phrase.

The system compares the input utterances to find acoustic models that best match the frame characteristics and determine corresponding representative text associated with the acoustic models. Typically, an acoustic model represents individual sounds, “phonemes,” as a sequence of statistically modeled acoustic states, for example, using hidden Markov models.

State sequence models can be scaled up to represent words as connected sequences of acoustically modeled phonemes, and phrases or sentences as connected sequences of words. When the models are organized together as words, phrases, and sentences, additional language-related information is also typically incorporated into the models in the form of language modeling.

The words or phrases associated with the best matching model structures are referred to as recognition candidates or hypotheses. A system may produce a single best recognition candidate—the recognition result—or a list of several hypotheses, referred to as an N-best list. Further details regarding continuous speech recognition are provided in U.S. Pat. No. 5,794,189, entitled “Continuous Speech Recognition,” and U.S. Pat. No. 6,167,377, entitled “Speech Recognition Language Models,” the contents of which are incorporated herein by reference.

Speech recognition can be classified as being either speaker independent or speaker dependent. Speaker independent systems use generic models that are suitable for speech inputs from multiple users. This can be useful for constrained vocabulary applications such as interactive dialog systems which have a limited recognition vocabulary.

The models in a speaker dependent system, by contrast, are specific to an individual user. Known speech inputs from the user are used to adapt a set of initially generic recognition models to specific speech characteristics of that user. The speaker adapted models form the basis for a user profile to perform speaker dependent or speaker adapted speech recognition for that user.

In contrast to constrained dialog systems, a dictation application has to be able to correctly recognize an extremely large vocabulary of tens of thousands of possible words which are allowed to be spoken continuously according to natural grammatical constraints. A system which satisfies such criteria is referred to as a Large Vocabulary Continuous Speech Recognition (LVCSR) system.

Speaker dependent systems traditionally use an enrollment procedure to initially create a user profile and a corresponding set of adapted models before a new user can use the system to recognize unknown inputs. During the enrollment procedure, the new user provides a speech input following a known source script that is provided. During this enrollment process, the speech models are adapted to the specific speech characteristics of that user. These adapted models form the main portion of the user profile and are used to perform post-enrollment speech recognition for that user. Further details regarding speech recognition enrollment are provided in U.S. Pat. No. 6,424,943, entitled “Non-Interactive Enrollment in Speech Recognition,” the contents of which are incorporated herein by reference.

In the past, to achieve good performance, the enrollment processes for LVCSR systems could take as long as ten or fifteen minutes of reading aloud by the user, followed by many more minutes of “digesting” while the system processed the enrollment speech to create the user profile for adapting the recognition models to that speaker. Thus, a user's first experience with a new dictation application may be a lengthy and unsatisfying process before the application can be used as intended. Recently, the duration of the enrollment has decreased significantly, but the process is still required for existing speaker dependent systems, especially LVCSR systems.

### SUMMARY OF THE INVENTION

Embodiments of the present invention create a user profile for large vocabulary continuous speech recognition without first requiring an enrollment procedure. The user profile includes speech recognition information associated with a specific user. Large vocabulary continuous speech recognition is performed on unknown speech inputs from the user utilizing the information from the user profile.

In further specific embodiments, performing large vocabulary continuous speech recognition includes performing unsupervised adaptation such as feature space adaptation or model space adaptation. The adaptation may include accumulating adaptation statistics after each utterance recognition. The adaptation statistics may be computed based on the speech input of the utterance and the corresponding recognition result. An adaptation transform may be updated after every number M utterance recognitions. Some number T seconds worth of recognition statistics may be required to perform the adaptation transform.

In one specific embodiment, the adaptation is based on Constrained Maximum Likelihood Linear Regression (CMLLR) adaptation. This may include updating a CMLLR transform using adaptation statistics accumulated with a forgetting factor, such as multiplying an accumulated statistic by a configurable factor after the statistic has been used to update CMLLR transform some number N times. The CMLLR transformation may use adaptation statistics accumulated using some fraction F of highest probability Gaussian components of aligned hidden Markov model states. The CMLLR transform may be initialized from a pre-existing transform such as an MLLR transform when a new transform is computed.

In some embodiments, the unsupervised adaptation may be coordinated with processor load so as to minimize recognition latency effects.

The user profile may include a stable transform based on supervised or unsupervised adaptation modeling relatively static acoustic characteristics of the user and acoustic environments; and/or a dynamic transform based on unsupervised adaptation modeling relatively dynamic acoustic characteristics of the user and acoustic environments. The user profile may also contain information for other kinds of model space adaptation such as MAP adapted model parameters. One or both of these transforms may be based on CMLLR. Embodiments may update the user profile using unknown speech inputs and the corresponding recognized texts. The speech recognition may use scaled integer arithmetic.

### BRIEF DESCRIPTION OF THE DRAWINGS

FIG. 1 shows the main functional steps in one embodiment of the present invention.

FIG. 2 shows various functional blocks in a system according one embodiment.

### DETAILED DESCRIPTION OF SPECIFIC EMBODIMENTS

Embodiments of the present invention are directed to large vocabulary continuous speech recognition (LVCSR) that does not require an initial enrollment procedure. An LVCSR application creates a user profile which includes speech recognition information associated with a specific user. After the user profile is created, the user may commence using the LVCSR application for speech recognition of unknown speech inputs from the user utilizing the information from the user profile.

Embodiments are based on use of a speaker-specific transform based on unsupervised adaptation which uses recognition results as feedback to update the speaker transform. In some specific embodiments, the adaptation is referred to as Online Unsupervised Feature space Adaptation (OUFA) and the adaptation transform is a feature space transform based on Constrained Maximum Likelihood Linear Regression (CMLLR) adaptation, first described in M. J. F. Gales, “Maximum Likelihood Linear Transformations For HMM-Based Speech Recognition”, Technical Report TR. 291, Cambridge University, 1997, the contents of which are incorporated herein by reference. In other embodiments, the adaptation is a model space adaptation which, for example, may use a CMLLR transform or other type of MLLR transform.

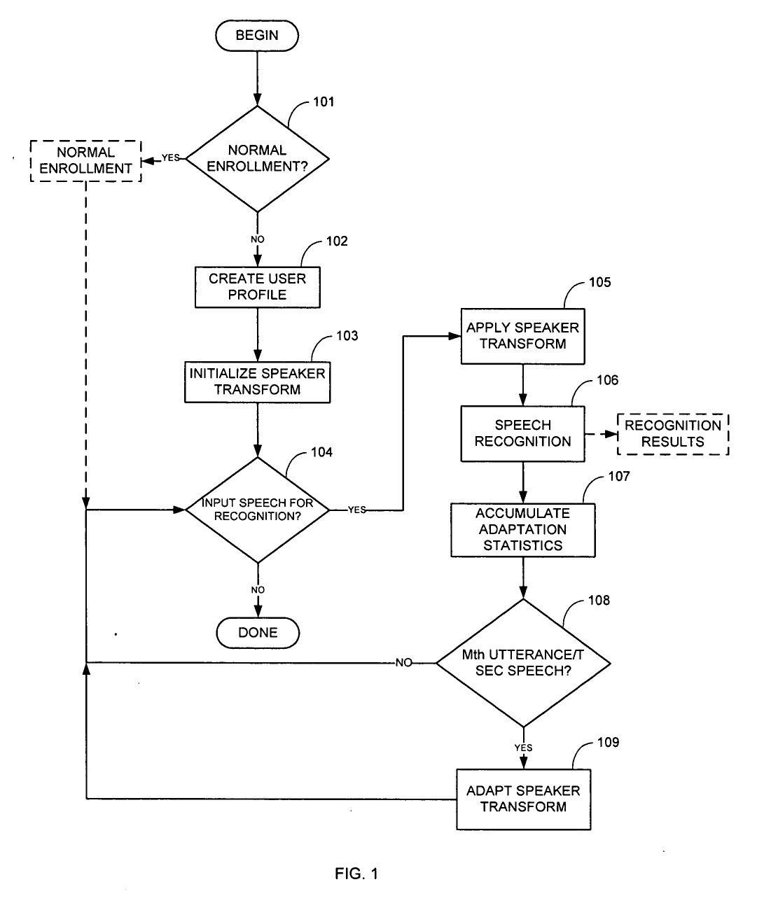

FIG. 1 shows the main functional steps in an embodiment. When a new user first starts the LVCSR application, they are asked if they want to perform a normal four minute enrollment procedure, step 101. If the answer is yes, a normal enrollment procedure (i.e., supervised adaptation) commences. Otherwise, a new user profile is created, step 102, without requiring enrollment.

The user profile stores information specific to that user and may reflect information from one or more initial audio setup procedures such as an initial Audio Setup Wizard procedure for the microphone. For example, after performing a cepstral mean subtraction (CMS), recognition may be performed on the ASW input (without biasing to the ASW text) and the recognized text of that used to compute a spectral warp factor (vocal tract normalization). The warp factor is used to scale the frequency axis of incoming speech so that it is as if the vocal tract producing the input speech was the same (hypothetical) vocal tract used to produce the acoustic models. For example, spectral warping may be based on a piecewise linear transformation of the frequency axis, further details of which are well-known in the art, and may be found, for example, in S. Wegmann, D. McAllaster, J. Orloff, and B. Peskin, Speaker Normalization On Conversational Telephone Speech, Proceedings of the IEEE International Conference on Acoustics, Speech, and Signal Processing ICASSP'96, Volume 1, pages 339-343, Atlanta (Ga.), USA, May 1996, the contents of which are incorporated herein by reference. Thus, initially, the user profile reflects CMS and spectral warping for the new user.

After a new user profile is first created, step 102, embodiments next initialize an adaptive speaker transform, step 103. In the specific embodiment shown, the speaker transform is based on a Constrained Maximum Likelihood Linear Regression (CMLLR) approach using online unsupervised adaptation statistics from the recognition results. The resulting dynamic speaker transform is relatively responsive to the immediate acoustic environment, for example, spectral variations reflecting specific user speech characteristics and specific characteristics of ambient noise. In some embodiments, the dynamic speaker transform may be complemented by a separate stable speaker transform which is relatively unresponsive to the immediate acoustic environment and may reflect speaker specific characteristics as determined by supervised adaptation such as from a traditional enrollment procedure and/or a post-enrollment acoustic optimization process. The speaker transform may be initialized, step 103, in a variety of specific ways. One approach is to initialize the speaker transform with an identity matrix. Another approach is to initialize the speaker transform from an inverse MLLR transform.

Once a user profile has been created and a speaker transform initialized, the system begins processing input speech for recognition. When an input utterance is present, step 104, the speaker transform is applied, step 105. That is, the input speech vectors for the current utterance are multiplied by the transform matrix that reflects the existing adaptive feature space transformation. Normal speech recognition of the transformed input speech is then performed, step 106, and output to the user's application. In addition, from the speech recognition results of each utterance recognition adaptation statistics are accumulated for the speaker transform, step 107. Every Mth utterance, step 108, for example, every third utterance, the adaptation statistics are used to adapt the speaker transformation, step 109, for example, by updating the CMLLR transform. In some embodiments, this updating may be conditioned on some number T seconds worth of recognition statistics having been collected, and/or whether processor load is relatively low. As when the speaker transform was first initialized, updating of the transform may start from applying the adaptation statistics to an identity matrix or the inverse of an MLLR transform, or from the existing CMLLR transform.

The cycle of input utterance recognition and online unsupervised adaptation repeats from step 104 so long as input speech is present. Once enough speech has been dictated into the system, the user may be encouraged to run or the system may automatically invoke unsupervised model space adaptation to further optimize acoustic models for the user. This acoustic model optimization process is typically an offline process because it requires a great deal of computational resources which are not available when the computing system is busy.

One typical environment for such an application would be a dictation application in a Windows, Macintosh, or Linux computer operating system; for example, Dragon Naturally Speaking by Nuance Communications, Inc. of Burlington, Mass. In such an application, a user sits before a computer video monitor and uses a microphone to enter input speech, which is recognized by the dictation application and displayed on the video monitor as representative text. LVCSR applications have also recently been implemented on portable devices such as cell phones and personal digital assistants (PDAs). In such applications, the use of LVCSR would be similar, with the user providing a speech input via a device microphone and seeing the recognition output as representative text on a device visual display.

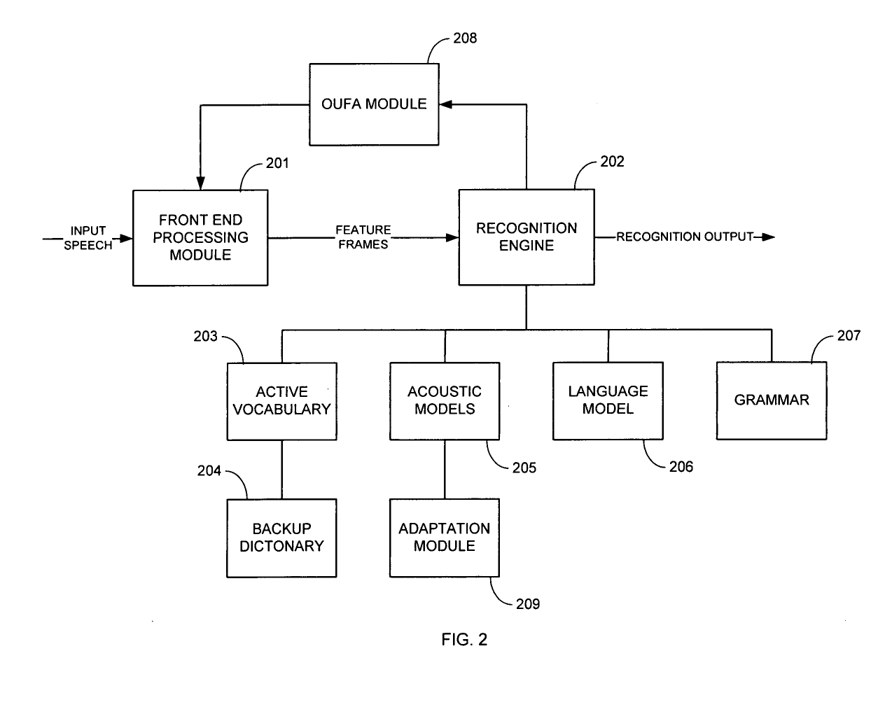

FIG. 2 shows various functional blocks in a system according to one embodiment. Generally, input speech is processed by Front End Processing Module 201 into a series of representative speech frames (multi-dimensional feature vectors) in the normal manner well-known in the art, including any cepstral mean subtraction, spectral warping, and application of the adaptive speaker transform described above. Recognition Engine 202 receives the processed and transformed input features and determines representative text as a recognition output. As explained in the Background section above, the Recognition Engine 202 compares the processed features to statistical Acoustic Models 205 which represent the words in the defined Active Vocabulary 203. The Recognition Engine 202 further searches the various possible acoustic model matches according to a defined Language Model 206 and a defined Recognition Grammar 207 to produce the recognition output. Words not defined in the Active Vocabulary 203 may be present in a Backup Dictionary 204 having entries available for use in the active vocabulary if and when needed.

Embodiments of the present invention which allow LVCSR without the usual enrollment procedure are based on an Online Unsupervised Feature space Adaptation (OUFA) Module 208 which uses an adaptive Constrained Maximum Likelihood Linear Regression (CMLLR) transform to best fit the feature vectors of a user in the current recognition environment to the model. OUFA uses adaptation data to determine a CMLLR linear transformation that consistently modifies both means and (diagonal) covariances of the Acoustic Models 205. Starting from the Gaussian mixture component distribution:
N(oₜ;μ, Σ)
   CMLLR determines a linear transform, A, of the acoustic model mean μ and covariance Σ which maximizes the likelihood of the observed adaptation data set O. The inverse of this transformation is applied by the OUFA Module 208 to the feature frames before they are output from the Front End Processing Module 201. The acoustic data used for this adaptation is unsupervised in that the user dictates text of his or her own choosing, generally with the aim of actually using the document(s) so produced. The Recognition Engine 202 recognizes this text and then uses the recognition results as if they were the correct transcription of the input speech. The OUFA Module 208 is “on-line” in the sense that it accumulates adaptation statistics after each utterance recognition. This is different from much unsupervised adaptation work where an utterance is recognized, the recognition results are used to update statistics, and then a re-recognition is performed. The OUFA Module 208 is more efficient because it does not require re-recognition.

As discussed above, the OUFA Module 208 can use the OUFA technique as a substitute for normal supervised enrollment. It is also useful even when the user has completed supervised enrollment or after the system completes acoustic model optimization with sufficient amount of input speech, for example, when the immediate acoustic environment during recognition differs from the acoustic environment that was present during enrollment.

In some embodiments, the OUFA Module 208 may accumulate CMLLR statistics with a “forgetting factor.” That is, after an accumulated statistic is used to update the speaker transform some number N times, it is multiplied by a configurable factor between 0 and 1 and new data is then added to the statistic without scaling.

In some embodiments, the OUFA Module 208 may further use-one or more additional optimizations to code for the speaker transform to make it run faster. For example, the OUFA Module 208 may accumulate the CMLLR statistics for some configurable fraction of the highest probability Gaussian components of the aligned acoustic model states. The algorithm that estimates the CMLLR transform also may be initialized from a pre-existing transform when a new transform is computed. The OUFA Module 208 also may postpone accumulation of statistics, and/or the computation and application of an updated CMLLR transform in coordination with processor load, for example, until the start of the next utterance recognition, to minimize recognition latency effects. In other words, adaptation can be delayed if the processor is busy with other tasks. Adaptation may also be run in a separate processor in a multi-core or multi-processor computer system.

Various other software engineering speedups may be usefully applied by the OUFA Module 208 including, without limitation, exploiting the symmetry of the accumulated statistics matrices to perform calculations on only half of each matrix for the CMLLR transform, using scaled integer arithmetic, converting divisions to multiplications where possible, precomputing reusable parts (e.g. denominators in the accumulation expressions), stopping accumulation of statistics early on very long utterances, coordinating the timing of the adaptation statistics accumulation and CMLLR transform update with processor load (e.g., temporarily suspend updating the CMLLR transform when processor load is high), and not accumulating statistics for initialization of the transform if initializing from the existing transform.

Specific embodiments may also employ other useful techniques. For example, after running for a while (i.e., after the system has processed a specific number of utterances or frames), the system may encourage users to run or automatically invoke an acoustic optimization process in which an Adaptation Module 209 re-adapts the users' Acoustic Models 205 using data collected from previously dictated documents. In the specific application of Dragon NaturallySpeaking, this optimization process is known as ACO (ACoustic Optimization). After running for awhile (i.e., after the system has processed a specific number of utterances or frames), unsupervised adaptation can be invoked using either or all of adaptation of the CMLLR transform, and/or MLLR transform, and/or MAP adaptation by the Adaptation Module 209 of the means and variances of the Acoustic Models 205. The CMLLR statistics may also be accumulated directly from the best acoustically scoring model state prior to final decoding. This would allow statistics accumulation in real time as opposed to in latency time, although it is possible that this might lead to a decrease in accuracy. The adaptation may be a feature space adaptation as described above, or similarly, model space adaptation may be used.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, DVD, flash memory devices, or hard disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or hard disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of speech recognition comprising:
creating a user profile for large vocabulary continuous speech recognition without using an enrollment procedure; and
performing large vocabulary continuous speech recognition of unknown speech inputs from the user utilizing the information from the user profile.

2. A method according to claim 1, wherein the performing large vocabulary continuous speech recognition includes performing unsupervised adaptation of the user profile.

3. A method according to claim 2, wherein the adaptation is a feature space adaptation.

4. A method according to claim 2, wherein the adaptation is a model space adaptation.

5. A method according to claim 2, wherein the adaptation includes accumulating adaptation statistics after each utterance recognition.

6. A method according to claim 5, wherein the adaptation statistics are computed based on the speech input of the utterance and the corresponding recognition result.

7. A method according to claim 2, wherein an adaptation transform is updated after every number M utterance recognitions.

8. A method according to claim 2, wherein some number T seconds worth of recognition statistics are required to update the adaptation transform.

9. A method according to claim 2, wherein the adaptation is based on Constrained Maximum Likelihood Linear Regression (CMLLR) adaptation.

10. A method according to claim 9, wherein the CMLLR adaptation includes updating a CMLLR transform using adaptation statistics accumulated with a forgetting factor.

11. A method according to claim 10, wherein the forgetting factor is based on multiplying an accumulated statistic by a configurable factor after the statistic has been used to update the CMLLR transform some number N times.

12. A method according to claim 9, wherein the CMLLR adaptation includes updating a CMLLR transform using adaptation statistics accumulated using some fraction F of highest probability Gaussian components of aligned hidden Markov model states.

13. A method according to claim 9, wherein the CMLLR adaptation includes using a CMLLR transform which is initialized from a pre-existing transform when a new transform is computed.

14. A method according to claim 9, wherein the CMLLR adaptation includes using a CMLLR transform which is initialized from an inverse of an MLLR transform.

15. A method according to claim 2, wherein performing unsupervised adaptation is coordinated with processor load so as to minimize recognition latency effects.

16. A method according to claim 1, wherein the user profile includes a stable transform based on supervised or unsupervised adaptation for modeling relatively static acoustic characteristics.

17. A method according to claim 16, wherein the transform is based on Constrained Maximum Likelihood Linear Regression (CMLLR).

18. A method according to claim 1, wherein the user profile includes a dynamic transform based on unsupervised adaptation for modeling relatively dynamic acoustic characteristics.

19. A method according to claim 18, wherein the transform is based on Constrained Maximum Likelihood Linear Regression (CMLLR).

20. A method according to claim 1, wherein the user profile includes speaker dependent acoustic models based on model space adaptation.

21. A method according to claim 20, wherein the transform is based on Constrained Maximum Likelihood Linear Regression (CMLLR).

22. A method according to claim 1, further comprising: updating the user profile using unknown speech inputs and the corresponding recognized texts.

23. A method according to claim 1, wherein the speech recognition uses scaled integer arithmetic.

24. A system for speech recognition comprising:
means for creating a user profile for large vocabulary continuous speech recognition without first requiring an enrollment procedure, the user profile including speech recognition information associated with a specific user; and
means for performing large vocabulary continuous speech recognition of unknown speech inputs from the user utilizing the information from the user profile.

25. A system according to claim 24, wherein the means for performing large vocabulary continuous speech recognition includes means for performing unsupervised adaptation of the user profile.

26. A system according to claim 25, wherein the adaptation is a feature space adaptation.

27. A system according to claim 25, wherein the adaptation is a model space adaptation.

28. A system according to claim 25, wherein the means for performing unsupervised adaptation accumulates adaptation statistics after each utterance recognition.

29. A system according to claim 28, wherein the adaptation statistics are computed based on the speech input of the utterance and the corresponding recognition result.

30. A system according to claim 25, wherein the means for performing unsupervised adaptation updates an adaptation transform after some number M utterance recognitions.

31. A system according to claim 25, wherein the means for performing unsupervised adaptation requires some number T seconds worth of adaptation statistics to update the adaptation transform.

32. A system according to claim 25, wherein the means for performing unsupervised adaptation is based on a Constrained Maximum Likelihood Linear Regression (CMLLR) adaptation.

33. A system according to claim 32, wherein the means for performing unsupervised adaptation includes means for updating a CMLLR transform using adaptation statistics accumulated with a forgetting factor.

34. A system according to claim 33, wherein the forgetting factor is based on multiplying an accumulated statistic by a configurable factor after the statistic has been used to update the CMLLR transform some number N times.

35. A system according to claim 32, wherein the means for performing unsupervised adaptation includes means for updating a CMLLR transform using adaptation statistics accumulated using some fraction F of highest probability Gaussian components of aligned hidden Markov model states.

36. A system according to claim 32, wherein the means for performing unsupervised adaptation uses a CMLLR transformation which is initialized from a pre-existing transform when a new transform is computed.

37. A system according to claim 32, wherein the means for performing unsupervised adaptation uses a CMLLR transformation which is initialized from an inverse of an MLLR transform.

38. A system according to claim 25, wherein the means for performing unsupervised adaptation coordinates with processor load so as to minimize recognition latency effects.

39. A system according to claim 24, wherein the user profile includes a stable transform based on supervised or unsupervised adaptation for modeling relatively static acoustic characteristics.

40. A system according to claim 39, wherein the transform is based on Constrained Maximum Likelihood Linear Regression (CMLLR).

41. A system according to claim 24, wherein the user profile includes a dynamic transform based on unsupervised adaptation for modeling relatively dynamic acoustic characteristics.

42. A system according to claim 41, wherein the transform is based on Constrained Maximum Likelihood Linear Regression (CMLLR).

43. A system according to claim 24, wherein the user profile includes speaker dependent acoustic models based on model space adaptation.

44. A system according to claim 43, wherein the transform is based on Constrained Maximum Likelihood Linear Regression (CMLLR).

45. A method according to claim 24, further comprising:
means for updating the user profile using unknown speech inputs and the corresponding recognized texts.

46. A system according to claim 24, wherein the means for performing large vocabulary continuous speech recognition uses scaled integer arithmetic.
